(19) United States
(12) Patent Application Publication
(10) Pub. No.: US 2006/0244896 A1
(43) Pub. Date: Nov. 2, 2006

(54) Spectacles and sunshade clip assembly using ornamental coupling structure

(76) Inventor: Heung-Woo Lee, Deagu (KR)

Correspondence Address: MAYER, BROWN, ROWE & MAW LLP, 1909 K STREET, N.W., WASHINGTON, DC, 20006, US

(21) Appl. No.: 11/116,206

(22) Filed: Apr. 28, 2005

(51) Int. Cl. G02C 5/00

(52) U.S. Cl. 351/41

(57) ABSTRACT

Disclosed herein is a spectacles and sunshade clip assembly using ornamental coupling structures. In the assembly, spectacles include a pair of lens frames each having a prescription lens fitted therein, and a pair of temple arms connected to opposite outer ends of both the lens frames by means of hinges in a foldable manner. A sunshade clip, to be detachably attached to a front side of the spectacles, include a pair of lens frames each having a tinted lens fitted therein, with a nose bridge. The sunshade clip is coupled to the spectacles by means of a pair of coupling structures integrally provided at opposite outer ends of the lens frames of the sunshade clip to protrude toward the spectacles to thereby couple the sunshade clip to the spectacles. Each coupling structure includes magnets embedded therein to produce a magnetic force required to couple the sunshade clip to the spectacles.

### BACKGROUND OF THE INVENTION

1. Field of the Invention

The present invention relates to a spectacles and sunshade clip assembly using ornamental coupling structures, and more particularly, to an ornamental coupling structure for use in a spectacles and sunshade clip assembly which can allow a sunshade clip to be more easily coupled to a front side of spectacles while achieving an improved appearance of the spectacles and sunshade clip assembly.

2. Description of the Related Art

Spectacles are optical instrument consisting of a pair of prescription lenses for correcting defective vision of a wearer, and mainly have substantially no sunlight-intercepting function. Therefore, when the wearer's eyes are exposed to high intensity ultraviolet rays of sunlight in the summer, there exists a necessity to wear sunglasses with tinted lens to protect the eyes from the sunlight, instead of wearing the ordinary spectacles.

However, sunglasses are not generally designed for persons wearing prescription lenses, and thus, persons, who require prescription lenses, have to order special sunglasses with prescription lenses conforming to their defective eyesight. This imposes a heavy cost burden on the wearer, and incurs an inconvenience in use, normally, having to alternately wear the sunglasses and spectacles.

In order to solve the above described problems, it has recently been proposed to detachably attach a sunshade clip to a front side of the ordinary spectacles. The sunshade clip is comprised of two lens frames with no temple arms, each of the frames having a tinted lens fitted therein, thereby providing the same effect as sunglasses.

Heretofore various technical solutions have been continuously developed and utilized to secure the sunshade clip to the spectacles by means of magnets. A representative example of the conventional technical solutions is shown in FIG. 6, and will be now explained in detail.

As shown in FIG. 6, which is a partially cut-away exploded perspective view illustrating spectacles and a sunshade clip in accordance with the prior art, the spectacles 10 comprise a pair of lens frames 2 each having a prescription lens 1 fitted therein, a nose bridge 3 interposed between the lens frames 2 to connect the lens frames 2 to each other, and a pair of temple arms 4 connected to opposite outer ends of both the lens frames 2 by means of L-shaped hinges 5. A sunshade clip 20, to which the spectacles 10 are detachably attached, comprises a pair of lens frames 22 each having a tinted lens 21 fitted therein, and a nose bridge 23 interposed between the lens frames 22 to connect the lens frames 22 to each other.

To secure the sunshade clip 20 to the spectacles 10, the nose bridges 3 and 23 of both the spectacles 10 and the sunshade clip 20 include respective permanent magnets 27 and 28 embedded in recesses 25 and 26 defined therein. Thereby, the sunshade clip 20 is able to be detachably attached to the spectacles 10 by making use of a magnetic force generated by the permanent magnets 27 and 28.

For the strong and stable engagement of the permanent magnets 27 and 28, as will be naturally expected, the nose bridge 23 of the sunshade clip 20 has an engagement extension 29 protruding toward the nose bridge 3 of the spectacles 10 to come into contact at a lower surface thereof with an upper surface of the nose bridge 3 of the spectacles 10. The recess 26 of the sunshade clip 20, embedded with the permanent magnet 28, is defined in the extension 29 of the nose bridge 23.

In the conventional solution to secure the sunshade clip to the spectacles by means of the permanent magnets embedded in their nose bridges, however, the overall sizes of both the nose bridges are excessively large due to the recesses for receiving the permanent magnets, imposing a heavy burden on the wearer's nose, and making the sunshade clip uncomfortable to wear. Further, the above described conventional securing manner considerably restricts the design of the sunshade clip and spectacles.

Moreover, according to the fact that the permanent magnets are mounted in the spectacles and the sunshade clip, respectively, both the permanent magnets must be accurately oriented relative to each other in predetermined directions to achieve maximum magnetic attraction therebetween. Otherwise, the sunshade clip may fail to be attached to the spectacles, resulting in deterioration in attachment efficiency and productivity of both the spectacles and the sunshade clip.

In addition, in the above described prior art configuration wherein the coupling of the spectacles and the sunshade clip depends on their nose frames only, even if the permanent magnets have strong magnetic force, they are barely able to stably bear the weight of the spectacles and the sunshade clip, and easily unintentionally detached from each other when an external force is applied thereto due to movement at the wearer.

Furthermore, the coupling of the prior art spectacles and sunshade clip simply focuses upon the coupling strength thereof without consideration of the aesthetic appearance of the resultant spectacles and sunshade clip assembly. Therefore, it is difficult to anticipate an ornamental effect from the prior art spectacles and sunshade clip assembly.

### SUMMARY OF THE INVENTION

Therefore, the present invention has been made in view of the above problems, and it is an object of the present invention to provide an ornamental coupling structure for use in a spectacles and sunshade clip assembly which can ensure strong coupling between spectacles and a sunshade clip while achieving an improved aesthetic appearance design of the spectacles and sunshade clip assembly.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a partially cut-away exploded perspective view illustrating a spectacles and sunshade clip assembly using ornamental coupling structures in accordance with a preferred exemplary embodiment of the present invention;

FIG. 2 is a partially cut-away perspective view of the sunshade clip of FIG. 1;

FIG. 3 is a partially cut-away perspective view illustrating a state wherein the sunshade clip is coupled to spectacles by means of the ornamental coupling structure;

FIG. 4 is a partially cut-away sectional view taken along line B-B of FIG. 3;

FIGS. 5A to 5C are partially cut-away perspective views illustrating different alternative configurations of the ornamental coupling structure used to couple the sunshade clip to the spectacles; and

FIG. 6 is a partially cut-away exploded perspective view of a representative example of spectacles and a sunshade clip in accordance with the prior art.

### DESCRIPTION OF THE PREFERRED EMBODIMENTS

Now, preferred embodiments of the present invention will be described in detail with reference to the annexed drawings.

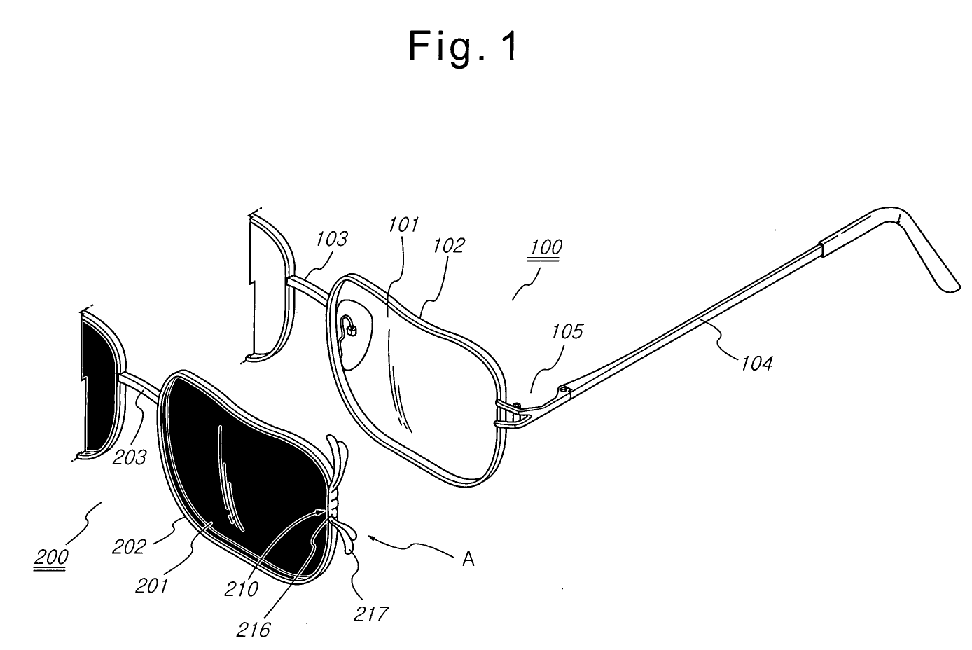

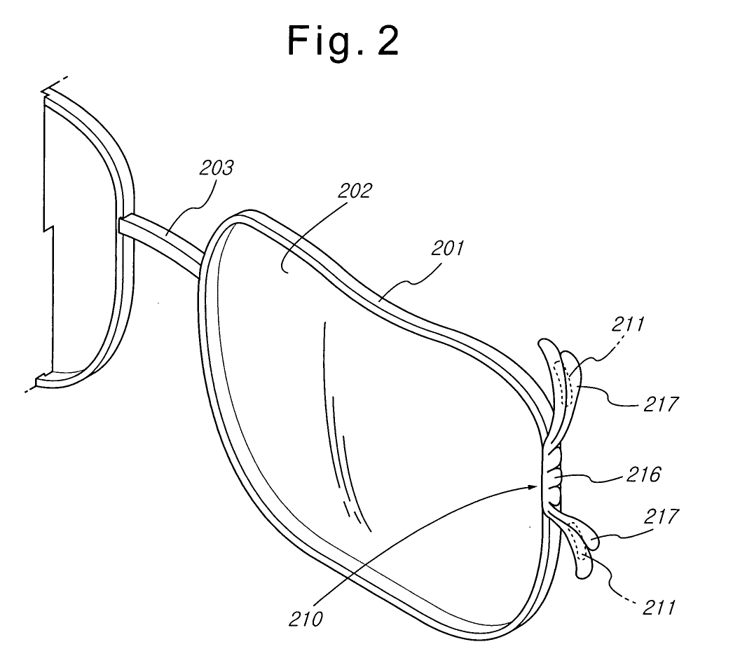

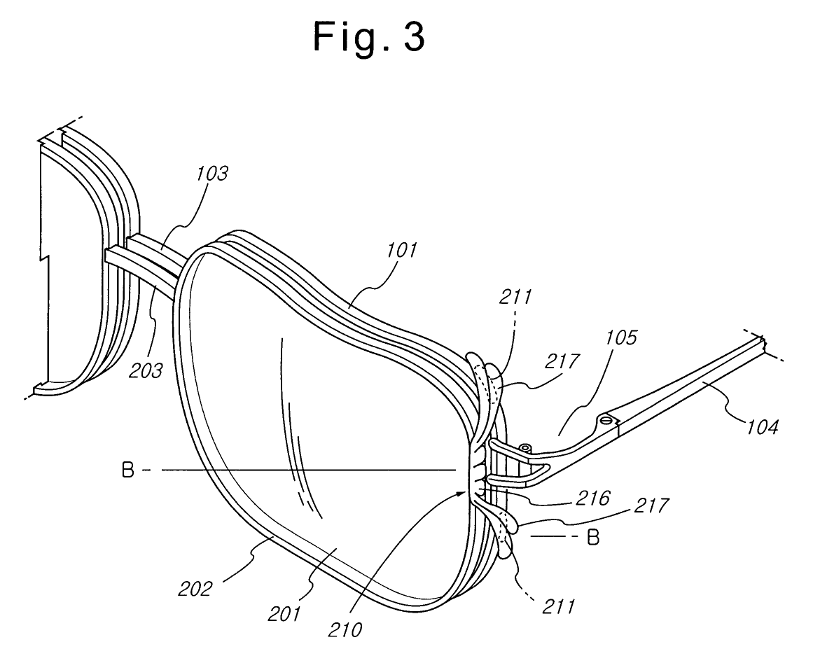

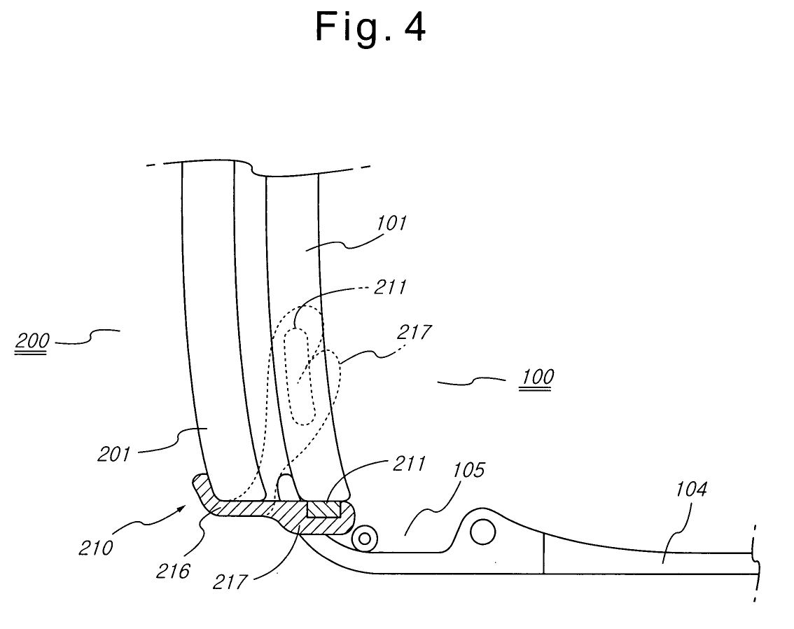

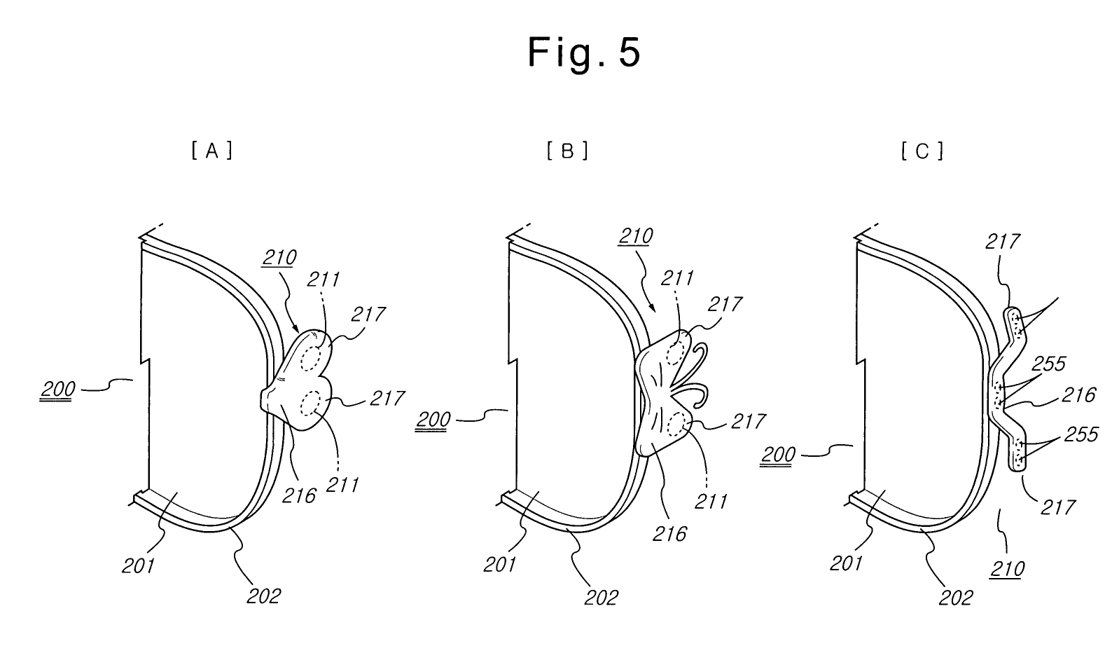

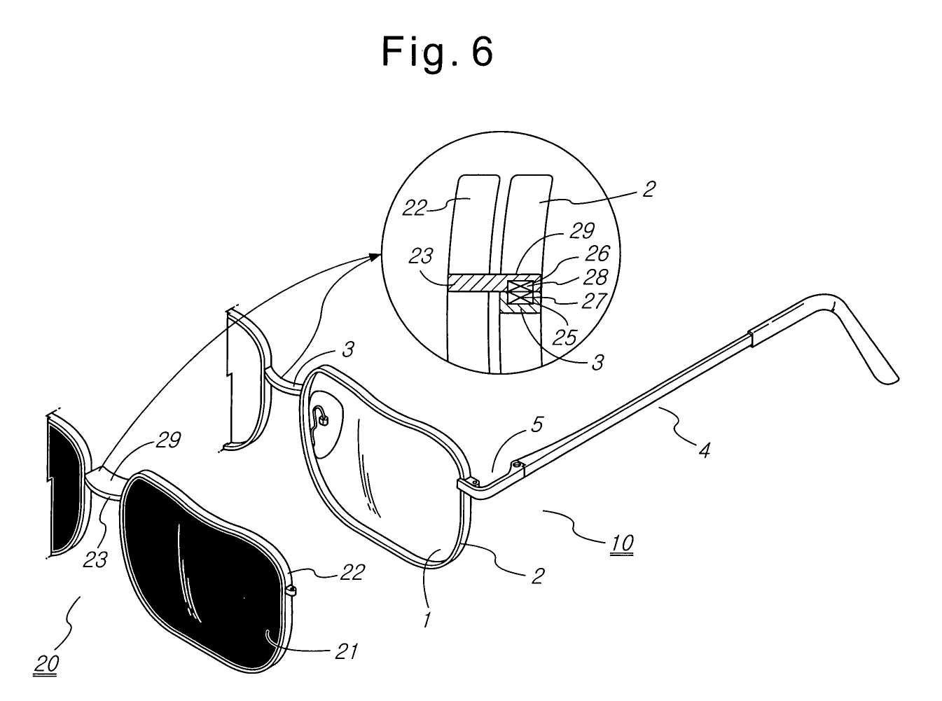

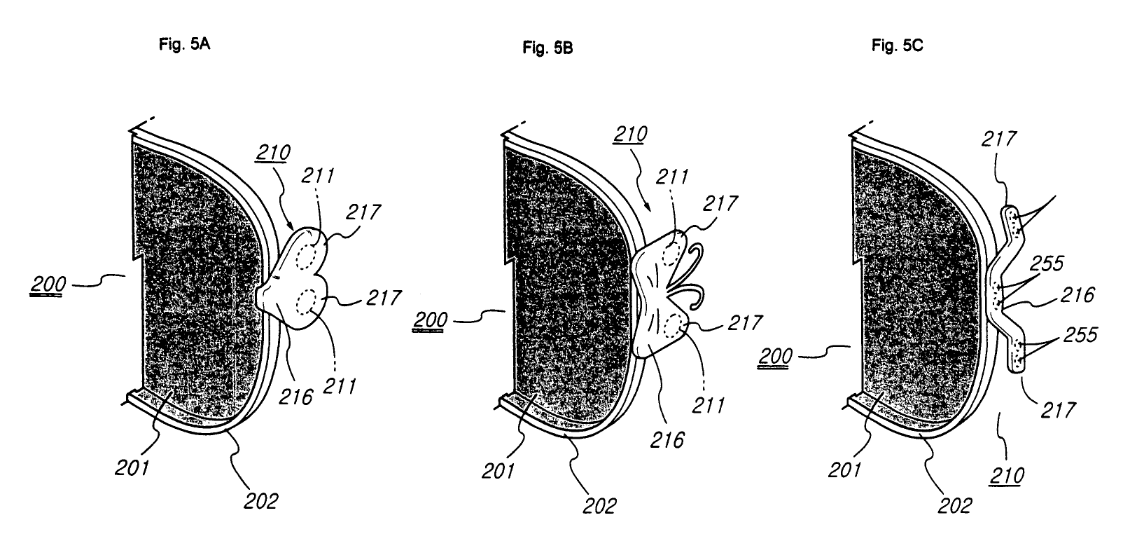

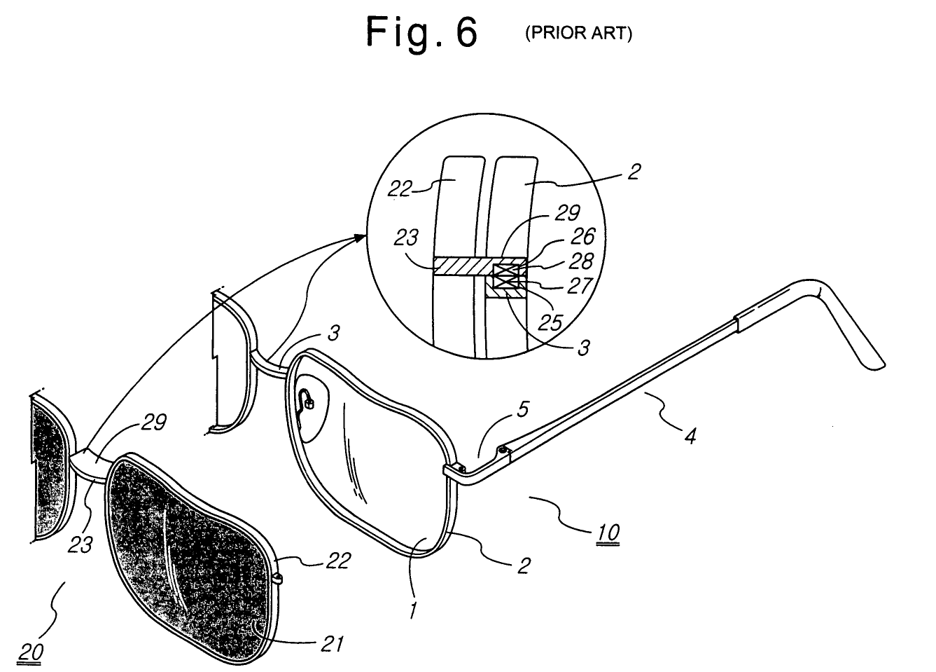

FIG. 1 is a partially cut-away exploded perspective view illustrating a spectacles and sunshade clip assembly using ornamental coupling structures in accordance with a preferred exemplary embodiment of the present invention. FIG. 2 is a partially cut-away perspective view of the sunshade clip of FIG. 1. FIG. 3 is a partially cut-away perspective view illustrating a state wherein the sunshade clip is coupled to spectacles by means of the ornamental coupling structure. FIG. 4 is a partially cut-away sectional view taken along line B-B of FIG. 3. FIGS. 5A to 5C are partially cut-away perspective views illustrating different alternative configurations of the ornamental coupling structure used to couple the sunshade clip to the spectacles.

As shown in FIGS. 1 and 2, in the spectacles and sunshade clip assembly using ornamental coupling structures in accordance with a preferred exemplary embodiment of the present invention, spectacles 100 comprise a pair of lens frames 102 each having a prescription lens 101 fitted therein, a nose bridge 103 interposed between the lens frames 102 to connect the lens frames 102 to each other, and a pair of temple arms 104 connected to opposite outer ends of both the lens frames 102 by means of L-shaped hinges 105.

A sunshade clip 200, configured to be detachably attached to a front side of the spectacles 100, comprises a pair of lens frames 202 each having a tinted lens 201 fitted therein, and a nose bridge 203 interposed between the lens frames 202 to connect the lens frames 202 to each other.

To couple the sunshade clip 200 to the spectacles 100, in the exemplary embodiment of the present invention, the sunshade clip 200 further comprises a pair of coupling structures 210 integrally provided at opposite outer ends of the lens frames 202 thereof to protrude toward the spectacles 100. Magnets 211 are embedded in each coupling structure 210 to be attached to the lens frame 102 of the spectacles 100 by means of a magnetic force of the magnets 211 in an assembled state of the spectacles 100 and the sunshade clip 200.

More specifically, the two coupling structures 210 are positioned at opposite outer ends of both the lens frames 202 of the sunshade clip 200 and are located to correspond to the hinges 105 that are used to connect the temple arms 104 to the lens frames 102. Further, each coupling structure 210 has a vertically extending elongated shape so that upper and lower ends thereof are located at upper and lower sides of the hinge 105 to stably hold the hinge 105 therebelow and support the hinge 105 thereabove.

In the preferred exemplary embodiment of the present invention, to achieve an aesthetically pleasing appearance, the coupling structure 210 is comprised of an ornamental body 216 to be affixed to the outer end of the lens frame 202 of the sunshade clip 200 by way of welding or bolt-fastening, and a pair of ornamental protrusions 217 extending from upper and lower ends of the body 216 toward the spectacles 100.

Although the coupling structure 210 of the preferred exemplary embodiment takes the form of a decorative ribbon, as will be naturally understood, the coupling structure 210 may be modified into other various shapes of coupling structures, such as for example, a heart shape coupling structure 230 (See FIG. 5A), butterfly shape coupling structure 240 (See FIG. 5B) or specific geometrical shape coupling structure 250 (See FIG. 5C).

Of course, it is also considerable to embed artificial jewels 255 in the body 216 and protrusions 217 of the coupling structure or to engrave or emboss various decorative patterns thereon, in order to achieve a more polished design.

With the present invention configured as stated above, in use, the spectacles 100 are normally used solely to correct defective vision of a wearer. If necessary, i.e. when it is desired to protect the wearer's eyes from high intensity ultraviolet rays of sunlight in the summer, the sunshade clip 200 is coupled to the front side of the spectacles 100 before or after the spectacles 100 are worn by the wearer.

After the spectacles 200 are coupled to the front side of the spectacles 100, the coupling structures 210, that are integrally formed at opposite outer ends of the lens frames 201 of the sunshade clip 200 to protrude toward the spectacles 100, are located at opposite outer sides of the lens frames 102 of the spectacles 100.

Thereby, the ornamental protrusions 217 of each coupling structure 210 are located at the upper and lower sides of the hinge 105, that is used to connect the temple arm 104 to the lens frame 102, thereby securely or stably holding the hinge 105 therebelow and supporting the hinge 105 thereabove.

In this case, the coupling structure 210 comes into close contact with the lens frame 102 by means of a magnetic force generated by the magnets 211 embedded in a surface thereof facing the lens frame 102. In this way, the sunshade clip 200 is securely coupled to the spectacles 100.

As will be easily understood from the above description, since the coupling structure 210 is intended to stably hold and support upper and lower sides of the lens frame 102, the resultant spectacles and sunshade clip assembly has substantially no risk of unintentional separation between the spectacles 100 and the sunshade clip 200 even if an external force, such as vibration, is applied thereto due to movement at the wearer.

Further, by virtue of the fact that the coupling structures 210 are formed at the outer ends of the lens frames 202, there is no restriction in the general design of the spectacles 100 and sunshade clip 200. By designing the coupling structure 210 to have an aesthetically pleasing appearance, it eventually results in an improvement in the appearance of the resultant spectacles and sunshade clip assembly.

As apparent from the above description, the present invention provides an ornamental coupling structure for use in a spectacles and sunshade clip assembly which can ensure strong coupling between spectacles and a sunshade clip while achieving an improved aesthetic appearance design of the resultant spectacles and sunshade clip assembly.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A spectacles and sunshade clip assembly comprising spectacles and a sunshade clip to be coupled to a front side of the spectacles, the spectacles including a pair of lens frames each having a prescription lens fitted therein, a nose bridge interposed between the lens frames to connect the lens frames to each other, and a pair of temple arms connected to opposite outer ends of both the lens frames by means of hinges in a foldable manner, the sunshade clip including a pair of lens frames each having a tinted lens fitted therein, and a nose bridge interposed between the lens frames to connect the lens frames to each other, further comprising:
a pair of coupling structures integrally provided at opposite outer ends of the lens frames of the sunshade clip to protrude toward the spectacles to thereby couple the sunshade clip to the spectacles,
wherein each coupling structure includes magnets embedded therein to produce a magnetic force required to attach the sunshade clip to the spectacles, and
wherein the coupling structure has an aesthetically pleasing appearance and is comprised of an ornamental body to be affixed to the outer end of the lens frame of the sunshade clip, and a pair of ornamental protrusions extending from upper and lower ends of the body toward the spectacles.

2. The assembly as set forth in claim 1, wherein the ornamental protrusions of the coupling structure are located at upper and lower sides of the hinge, that is used to connect the temple arm to the lens frame, thereby securely or stably holding the hinge therebelow and supporting the hinge thereabove.

3. The assembly as set forth in claim 1, wherein artificial jewels are embedded in the body and protrusions of the coupling structure, or various decorative patterns are engraved or embossed on the body and protrusions of the coupling structure.
